(19) United States
(12) Patent Application Publication
(10) Pub. No.: US 2022/0219729 A1
(43) Pub. Date: Jul. 14, 2022

(54) AUTONOMOUS DRIVING PREDICTION METHOD BASED ON BIG DATA AND COMPUTER DEVICE

(71) Applicant: Shenzhen Guo Dong Intelligent Drive Technologies Co., Ltd, Shenzhen (CN)

(72) Inventor: Jianxiong XIAO, Shenzhen (CN)

(73) Assignee: Shenzhen Guo Dong Intelligent Drive Technologies Co., Ltd, Shenzhen (CN)

(21) Appl. No.: 17/482,470

(22) Filed: Sep. 23, 2021

(30) Foreign Application Priority Data
Jan. 12, 2021 (CN) 202110037884.8

(51) Int. Cl. B60W 60/00; B60W 30/095

(52) U.S. Cl. CPC B60W 60/0011; B60W 60/0027; B60W 2556/05; B60W 2555/20; B60W 2554/4046; B60W 30/095

(57) ABSTRACT

An autonomous driving prediction method based on big data, wherein the autonomous driving prediction method based on big data includes steps of: providing a plurality of prediction algorithm models associated with a target road; obtaining sensing data of sensors, the sensing data including a current position of the autonomous driving vehicle, surrounding environment data of the autonomous driving vehicle, and, driving data of the autonomous driving vehicle; obtaining current scene data of the autonomous driving vehicle; loading the optimal prediction algorithm model; calculating current scene data of the autonomous driving vehicle by the optimal prediction algorithm model to obtain prediction data; generating a control command based on the prediction data; and controlling the autonomous driving vehicle to drive according to the control command.

### CROSS REFERENCE TO RELATED APPLICATION

This non-provisional patent application claims priority under 35 U.S.C. § 119 from Chinese Patent Application No. 202110037884.8 filed on Jan. 12, 2021, the entire content of which is incorporated herein by reference.

### TECHNICAL HELD

The disclosure relates to the field of autonomous driving, particularly relates to an autonomous driving prediction method based on big data and computer device.

### BACKGROUND

Nowadays, autonomous driving vehicles of level L4 are common autonomous driving vehicles capable of completing driving tasks without any human driver. It is very important for the autonomous driving vehicles of level L4 to perceive the trajectory of each obstacle encountered during driving to complete the driving tasks. Typical existing prediction methods for the autonomous driving vehicles of level L4 are based on machine learning algorithm or AI algorithm according to preset rules. For example, the AI algorithm collects a large number of obstacles' movement data and trains an AI model with the collected obstacles' movement data. In practical application, due to variety of road conditions, such as different terrains, different intersection shapes, different local people's driving styles, the general AI algorithm is difficult to deal with all kinds of road conditions comprehensively.

Therefore, how to make the autonomous driving vehicles of level L4 quickly and accurately predicts the trajectory of obstacles in a variety of road conditions is an urgent problem to be solved.

### SUMMARY

The disclosure provides an autonomous driving prediction method based on big data and a method and a computer device. The autonomous driving vehicles of level L4 can accurately perceive the trajectory of obstacles under various road conditions.

At a first aspect, an autonomous driving prediction method based on big data is provided. The autonomous driving prediction method based on big data including steps: providing a plurality of prediction algorithm models associated with a target road, the plurality of the prediction algorithm model matching sub road sections of the target road correspondingly; obtaining sensing data of sensors, the sensing data including a current position of the autonomous driving vehicle, surrounding environment data of the autonomous driving vehicle, and driving data of the autonomous driving vehicle; obtaining current scene data of the autonomous driving vehicle from the sensing data; obtaining an optimal prediction algorithm model matching to a current sub road section of the target road from the plurality of the prediction algorithm models based on the current scene data of the autonomous driving vehicle; loading the optimal prediction algorithm model; calculating current scene data of the autonomous driving vehicle by the optimal prediction algorithm model to obtain prediction data; generating a control command based on the prediction data; and controlling the autonomous driving vehicle to drive according to the control command.

At a second aspect, an artificial intelligence apparatus for an autonomous driving vehicle, is provided. The artificial intelligence apparatus includes a memory and one or more processors. The memory is configured to store program instructions. The one or more processors are configured to execute the program instructions to perform an autonomous driving prediction method based on big data, the autonomous driving prediction method based on big data for an autonomous driving vehicle includes steps of providing a plurality of prediction algorithm models associated with a target road, the plurality of the prediction algorithm model matching sub road sections of the target road correspondingly; obtaining sensing data of sensors, the sensing data including a current position of the autonomous driving vehicle, surrounding environment data of the autonomous driving vehicle, and, driving data of the autonomous driving vehicle; obtaining current scene data of the autonomous driving vehicle from the sensing data; obtaining an optimal prediction algorithm model matching to a current sub road section of the target road from the plurality of the prediction algorithm models based on the current scene data of the autonomous driving vehicle; loading the optimal prediction algorithm model; calculating current scene data of the autonomous driving vehicle by the optimal prediction algorithm model to obtain prediction data; generating a control command based on the prediction data; and controlling the autonomous driving vehicle to drive according to the control command.

As described above, the autonomous driving prediction method based on big data can provides a plurality of the prediction algorithm models associated with a plurality of road sections of the target road, when the autonomous driving vehicles is driving on the target road, the autonomous driving prediction method can enable the autonomous can select a prediction algorithm models matching for each the road sections correspondingly based on the current road condition, such that the autonomous driving vehicles can perceive the trajectory of all obstacles on the road section by the corresponding prediction algorithm model. As a result, the trajectories of the obstacles can be predicted quickly, the computing power of the autonomous driving vehicle can be also reduced and the reaction speed of autonomous driving vehicles is improved. Furthermore, the autonomous driving vehicles can drive better under a variety of road conditions.

### BRIEF DESCRIPTION OF THE DRAWINGS

In order to illustrate the technical solution in the embodiment of the disclosure or the prior art more clearly, a brief description of drawings required in the embodiment or the prior art is given below. Obviously, the drawings described below are only some of the embodiment of the disclosure. For ordinary technicians in this field, other drawings can be obtained according to the structures shown in these drawings without any creative effort.

FIG. 1 illustrates a flow chart diagram of an autonomous driving prediction method based on big data in accordance with a first embodiment, the autonomous driving prediction method include steps S101˜S108.

FIG. 2 illustrates a part of a flow chart diagram of the autonomous driving prediction method based on big data in accordance with a second embodiment.

FIG. 3 illustrates road sections in accordance with an embodiment.

FIG. 4 illustrates a sub flow chart diagram of one step of the autonomous driving prediction method based on big data in accordance with a first embodiment.

FIG. 5 illustrates a sub flow chart diagram of the one step of the autonomous driving prediction method based on big data in accordance with an embodiment.

FIG. 6 illustrates a sub flow chart diagram of the one step the autonomous driving prediction method based on big data in accordance with a second embodiment.

FIG. 7 illustrates a sub flow chart diagram of the one step of the autonomous driving prediction method based on big data in accordance with a third embodiment.

FIG. 8 illustrates a part of a flow chart diagram of the autonomous driving prediction method based on big data in accordance with a third embodiment.

FIG. 9 illustrates a block diagram of an computer device in accordance with a first third embodiment.

FIG. 10 illustrates a driving autonomous vehicle in accordance with the third embodiment.

### DETAILED DESCRIPTION OF THE EMBODIMENT

In order to make the purpose, technical solution and advantages of the disclosure more clearly, the disclosure is further described in detail in combination with the drawings and embodiment. It is understood that the specific embodiment described herein are used only to explain the disclosure and are not used to define it. On the basis of the embodiment in the disclosure, all other embodiment obtained by ordinary technicians in this field without any creative effort are covered by the protection of the disclosure,

The terms “first”, “second”, “third”, “fourth”, if any, in the specification claims and drawings of this application are used to distinguish similar objects and need not be used to describe any particular order or sequence of priorities. It should be understood that the data used here are interchangeable where appropriate, in other words, the embodiment described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the disclosure are for descriptive purpose only and neither be construed or implied the relative importance nor indicated as implying the number of technical features. Thus, feature defined as “first” or “second” can explicitly or implicitly include one or more such features. In addition, technical solutions between embodiment may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

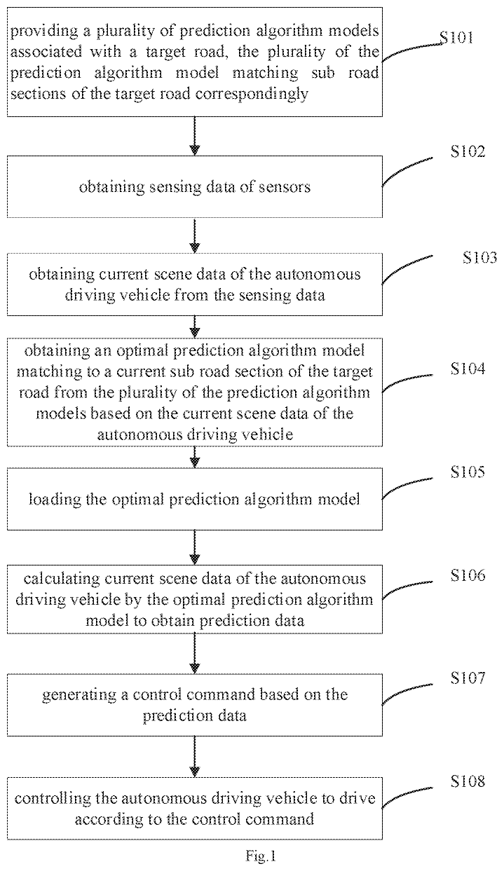

Referring to FIG. 1, FIG. 1 illustrates a flow chart diagram of an autonomous driving prediction method based on big data in accordance with the first embodiment. The autonomous driving prediction includes the following steps.

In step S101, a plurality of prediction algorithm models associated with a target road is provided, the plurality of the prediction algorithm model matches sub road sections of the target road correspondingly. Each prediction algorithm model is constructed under a condition of performing multiple road tests by road test vehicles in a corresponding scene of each of the sub road sections. The target road is a road section where the road test vehicles conduct a lot of road tests, the road test vehicles are autonomous road test vehicles. For example, the road test vehicles conduct road tests on the Bao'an highway in Jiading District of Shanghai, in other words, the Bao'an highway is the target road. The sub road sections, such as crossroads, T-junctions, straight section and other sub road sections, are selected from the Bao'an highway to construct the algorithm models. The prediction algorithm models are constructed under the conditions of performing multiple road tests by road test vehicles on sub road sections of the Bao'an highway to collect the information of the intersections, the T-junctions, and the straight sections and matches with the cross-intersection, T-junction and straight sections of Bao'an highway correspondingly. The autonomous driving prediction method based on big data provides multiple prediction algorithm models associated with Bao'an highway in Jiading District of Shanghai.

In step S102, sensing data of sensors is obtained, the sensing data includes a current position of the autonomous driving vehicle, surrounding environment data of the autonomous driving vehicle, and driving data of the autonomous driving vehicle. In detail, the sensing data includes the autonomous driving vehicle, for example drive at an intersection of the Bao'an highway in Jiading District of Shanghai at current that the intersection of Bao'an highway in Jiading District of Shanghai is the current position. The surrounding environment data indicates that traffic lights are located in front of the driving direction and the current driving direction is southwest. The driving data includes operation data for controlling the autonomous driving vehicle to drive when the autonomous driving vehicle reaches the intersection of the Bao'an highway, such as speed data indicating that the autonomous driving vehicle should drive at 30 km/h, or direction data indicating that in which direction the autonomous driving vehicle should drive, or control data indicating that the autonomous driving vehicle should accelerate and decelerate, and so on.

In step S103, current scene data of the autonomous driving vehicle is obtained from the sensing data. The scene data is characteristic of a specific scene. For example, the characteristic data of an intersection scene is the intersection and the traffic lights described in step 102. The autonomous driving vehicle can confirm that the current scene is intersection scene 200 according to the characteristic data such as the intersection and traffic lights.

In step S104, an optimal prediction algorithm model is obtained matching to a current sub road section of the target road from the plurality of the prediction algorithm models based on the current scene data of the autonomous driving vehicle. In detail, the autonomous driving vehicle searches the multiple prediction algorithm models for the prediction algorithm model that matches the intersection scene, and takes the prediction algorithm model as the optimal prediction algorithm model. It is understood that, each of the plurality of the prediction algorithm models associated with two or more different sub road sections which has the same characteristic of the same scene, and the different sub road sections can be road sections of the target road or non-target roads.

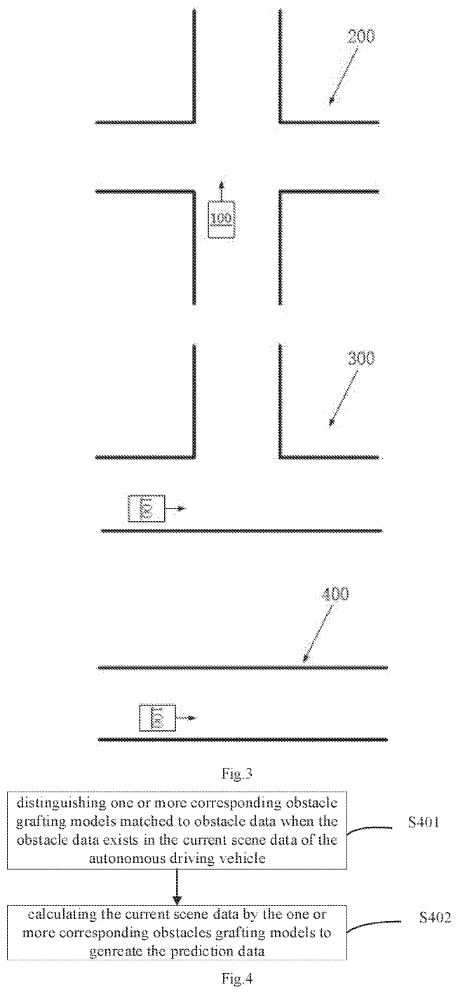

In step S105, the optimal prediction algorithm model is loaded. In detail, as shown in FIG. 3, the prediction algorithm model of intersection scenario 200 has been loaded when the autonomous driving vehicle drives to the intersection.

In step S106, the current scene data of the autonomous driving vehicle is calculated to obtain prediction data by the optimal prediction algorithm model. The prediction data includes prediction trajectory data of the obstacles existing in the intersection scene 200 where the autonomous driving vehicle arrived at, the prediction speed of the autonomous driving vehicle in the intersection scene 200 and so on.

In step S107, a control command is generated based on the prediction data. the prediction data includes the speed and the driving direction of the autonomous driving vehicle. In detail, the autonomous driving vehicle calculates the speed and the driving direction of the autonomous driving vehicle according to the predicted trajectory data and predicted speed of the obstacles in the current scene.

In step S108, the autonomous driving vehicle is controlled to drive according to the control command. In detail, the autonomous driving vehicle drives according to the speed, the driving direction and other control commands.

In this embodiment, the autonomous driving vehicle confirms the current scene of the autonomous driving vehicle according to the sensing data, and matches the most suitable prediction algorithm model according to the scene. Further, the autonomous driving vehicle can calculate the trajectory of the obstacles in the scene according to the prediction algorithm model, so that the autonomous driving vehicle can obtain the trajectory of the obstacles quickly, and improve the adaptability of the autonomous driving vehicle to the environment, and enable the autonomous driving vehicle to complete a driving task with a more optimized path that it improves the riding experience of passengers of autonomous driving vehicles.

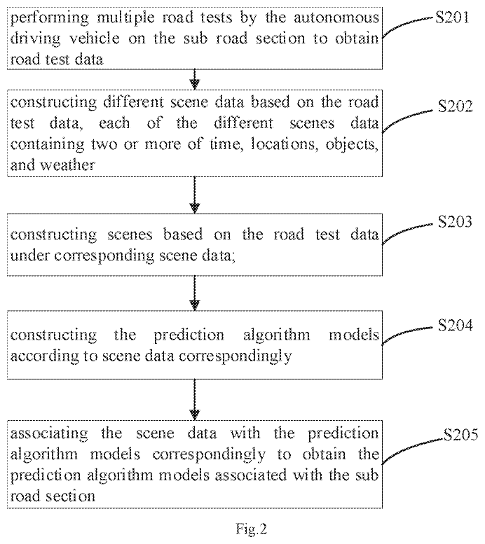

Referring to FIG. 2, FIG. 2 illustrates a part of a flow chart diagram of the autonomous driving prediction method based on big data in accordance with a second embodiment. In this embodiment, the autonomous driving prediction method further includes following steps.

In step S201, multiple road tests are performed by the autonomous driving vehicle on the sub road section to obtain road test data. The sub road sections include interest road sections at intersections and/or at non intersections. The sub road section can be cross-intersection, T-shaped intersection, straight road section, etc. The description here is only for example, not for limitation. Referring to FIG. 3, the road test vehicle carries out several road tests at a certain intersection scene 200 of Bao'an highway in haling. District of Shanghai to collect a large number of road test data of a current intersection scene 200, the road test vehicle carries out several road tests at a T-junction scene 300 of Bao'an highway in Jiading District of Shanghai to collect a large number of road test data of a current T-junction scene 300; the road test vehicle carries out several road tests at a straight road section to collect a large number of road test data of a current straight road section scene 400 of Bao'an highway in Jiading District of Shanghai.

In step S202, different scene data is constructed based on the road test data, each of the different scenes data contains two or more of time, locations, objects, and weather. For example, at 8:00 a.m., the weather is fine, and the autonomous driving vehicles pass through the intersection scene at 200 a.m,, and the data such as 8:00 a.m., the vehicles driving in the same direction around, and the weather is fine are collected. In other words, the scene data of an intersection includes time, location, surrounding objects and weather. The specific data is determined by the actual situation not limited to the ample described above.

In step S203, scenes are constructed based on the road test data under corresponding scene data. In detail, the corresponding scene characteristic data is calculated to represent the corresponding scenes according to the time, the location, the surrounding objects, and weather of the intersection scene 200.

In step S204, prediction algorithm models are constructed according to scene data correspondingly. In detail, the predication algorithm models corresponding to the scenes are constructed according to the corresponding time, location, surrounding objects and weather.

In step S205, the scene data is associated with the prediction algorithm models correspondingly to obtain the prediction algorithm models associated with the sub road section. In detail, the intersection scene 200 is associated with corresponding prediction algorithm model by the same feature data.

As described above, the corresponding prediction algorithm models are constructed according to the scene constructed by multiple road test data, the autonomous driving vehicle analyzes prediction trajectories of the obstacles. The autonomous driving vehicle can load a more suitable prediction algorithm model to perceive the obstacle trajectory that it can save the computing power and improve the adaptability of the autonomous driving vehicle to the environment.

Referring to FIG. 4, FIG. 4 illustrates a sub step flow chart of step S201 in accordance with a first embodiment of the autonomous driving prediction method based on big data. In this embodiment, the prediction algorithm models contain one or more obstacle grafting models for the corresponding sub road sections, each of the obstacle grafting models is a trajectory model of an obstacle with specific behavior in corresponding sub road sections. The step S201 includes the following steps.

In step S401, one or more corresponding obstacle grafting models matched to obstacle data are distinguished when the obstacle data exists in the current scene data of the autonomous driving vehicle. The obstacle data includes type data for indicating the obstacle type, behavior data for indicating behavior characteristics of the obstacle, and sub road sections where the obstacle is located.

In step S402, the current scene data is calculated by the one or more corresponding obstacles grafting models to generate the prediction data.

In the above embodiment, once a specific obstacle is detected, the trajectory of the obstacle in the existing obstacle grafting model can be grafted to the current obstacle, so that the predicted trajectory of the obstacle can be calculated with less computational power, It improves the reaction speed of autonomous driving vehicles to avoid obstacles.

Referring to FIG. 5, FIG. 5 illustrates a sub-flow chart diagram of the step 401 of the autonomous driving prediction method in accordance with an embodiment. In detail, the step S401 includes the following steps.

In step S501, one or more obstacle grafting models are distinguished. The one or more obstacle grafting models match to the sub road sections where the obstacle is located. In detail, the autonomous driving vehicle distinguishes a plurality of obstacle grafting models matching to the intersection where the obstacle is located according to the information of the intersection, such as pedestrian model, vehicle model and traffic light model.

In step S502, one or more obstacle grafting models are distinguished, the one or more obstacle grafting models match to the type data from the one or more obstacle grafting models matching to the sub road sections. In detail, according to the information of pedestrians, the autonomous driving vehicle distinguishes a plurality of obstacle grafting models matching to the pedestrians at the intersection where the obstacles are located, such as the pedestrian model crossing the road and the pedestrian model waiting to cross the road.

In step S503, one or more obstacle grafting models are distinguished, the one or more obstacle grafting models are matched to behavior data from the one or more obstacle grafting models matching to the type data. In detail, according to the speed information of pedestrians, the autonomous driving vehicle distinguishes a plurality of obstacle grafting models related to the speed of pedestrians at the intersection where the obstacle is located, for example, the pedestrian model crossing the road.

In the above embodiment, according to the type data of the obstacle type, the behavior data used to represent the behavior characteristics of the obstacle, the sub road sections where the obstacle is located and other data, the most matching obstacle trajectory grafting model in the current environment is selected and grafted to the current obstacle. It reduces the computing power of the autonomous driving vehicle, improves the recognition performance of the autonomous driving vehicle, and processes all kinds of obstacle information more quickly.

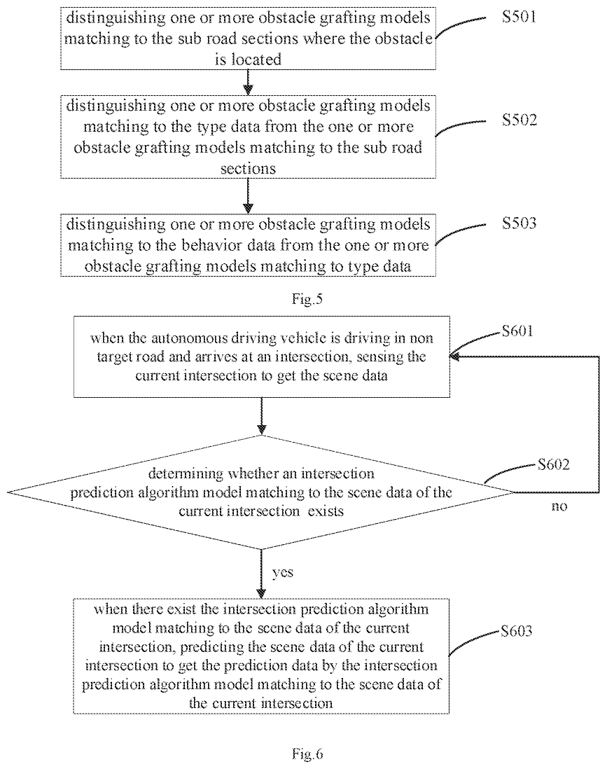

Referring to FIG. 6, FIG. 6 illustrates a sub flow chart diagram of the step S201 in accordance with a second embodiment. In this embodiment, the prediction algorithm model contains one or more intersection prediction algorithm models associated with the intersection. In detail, the step S201 includes the following steps.

In step S601, when the autonomous driving vehicle is driving in non target road and arrives at an intersection, the current intersection is sensed to get the scene data. In detail, the autonomous driving vehicle perceives the road condition of the current intersection, which may be a cross intersection, a T-junction intersection or other road intersections. In this embodiment, the current intersection is perceived by the autonomous driving vehicle is the cross intersection.

In step S602, it is determined that whether an intersection prediction algorithm model matching the scene data of the current intersection exists or not. In detail, the autonomous driving vehicles determines whether there is an intersection prediction algorithm model matching the cross intersection scene data.

In step S603, when there exists the road section prediction algorithm model matching to the scene data, the scene data is calculated to get the prediction data by the road section algorithm model matching to the scene data of the current intersection. In detail, when there is an cross intersection prediction algorithm model that matches the scene data of the intersection, the autonomous driving vehicle uses the intersection prediction algorithm model to perceive the scene data of the intersection to get the prediction data. For example, when an autonomous vehicle arrives at the current intersection which is the cross intersection, it loads the cross intersection prediction algorithm model of the intersection in advance, the cross intersection prediction algorithm model is activated to perceive the predicted trajectory of pedestrians at the intersection according to the pedestrian data perceived at the cross intersection.

In some embodiment, the sub road sections with similar environment can share the same prediction algorithm model to effectively improve the utilization rate of the algorithm.

As described above, each intersection algorithm prediction model only corresponds to one type of intersection scene, and the data to be calculated is greatly reduced, thus the difficulty of algorithm calculation reduce greatly. When the autonomous driving vehicle drives to the current intersection, the intersection prediction algorithm model of the intersection is loaded in advance to enable the autonomous driving vehicle to enter intersection prediction algorithm model, so as to save computing power and reduce delay.

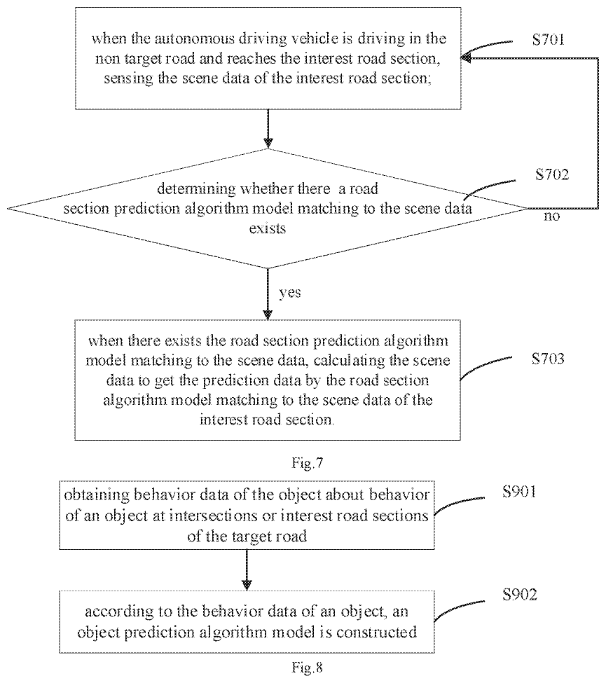

Referring to FIG. 7, FIG. 7 illustrates a sub flow chart diagram of the step S201 in accordance with a third embodiment. In this embodiment, the prediction algorithm model contains one or more section prediction algorithm models associated with the intersection. In detail, the step S201 includes the following steps.

In step S701, when the autonomous driving vehicle is driving in a non target road section and reaches the interest road section of the non target road section, the scene data of the interest road section of the current non intersection is sensed. In detail, the autonomous driving vehicle senses the road conditions of the current non-intersection of interest road sections. The interest road section may be a straight section on flat ground, a straight section of uphill, a straight section of downhill, or other straight sections that exist in actual roads. In this embodiment, the current road section perceived by the autonomous vehicle is a straight road section on flat ground. The straight road section on flat ground is a road section of interest that is not currently at an intersection

In step S702, it is determined whether there exists a road section prediction algorithm model matching to the scene data or not. For example, the autonomous driving vehicle determines whether there is a road section prediction algorithm model that matches the scene data of straight road section on flat ground.

In step S703, when there exists the road section prediction algorithm model matching to the scene data, calculating the scene data to get the prediction data by the road section algorithm model matching to the scene data of the the interest road section. In detail, when there is a road section prediction algorithm model that matches the scene data of the straight road section on the flat ground, the autonomous driving vehicle uses the road section prediction algorithm model to perceive the scene data of the straight road section on the flat ground to get the prediction data. For example, when the autonomous driving vehicle drives to the current road section, it loads the road section prediction algorithm model of the road section in advance and enters into the road section prediction algorithm model. According to the perceived vehicle data of the straight road section on the flat ground, the road section prediction algorithm model predicts that the autonomous driving vehicle drives straightly along the current driving along current road, and less likely to change lanes, and the speed of the autonomous driving vehicle is 50 km/h.

In the above embodiment, each road section algorithm prediction model is only associated to one type of the scene, and the data to be calculated is greatly reduced, thus the difficulty of algorithm calculation is greatly reducing. When the autonomous driving vehicle arrives at the current road section, the road section prediction algorithm model of the road section is loaded in advance to enable the autonomous driving vehicle to enter the road section prediction algorithm model to save computing power and reduce delay.

Referring to FIG. 8, FIG. 8 illustrates an autonomous driving prediction method in accordance with a third embodiment. In this embodiment, the prediction algorithm models contain one or more object prediction algorithm models associated with an object, each of the object prediction algorithm models is trajectory algorithm model for a corresponding object when the object is sensed, the object is predicted to get the prediction data by one or more object prediction algorithm models associated with the object. Accordingly, the autonomous driving prediction method based on big data in accordance with a third embodiment includes the following steps.

In step S901, the behavior data of an object is obtained, the behavior data of an object includes the behavior data of an object at the intersection and/or the road section of interest. In detail, the autonomous driving vehicle obtains the driving data of other driving vehicles, such as the straight speed of the vehicle in the straight road section, the turning speed of the vehicle when turning at the intersection, and the climbing speed of the vehicle when climbing in a straight line.

In step S902, one or more object prediction algorithm model are constructed according to the behavior data of an object. In detail, the autonomous driving vehicle prediction algorithm model is constructed according to the turning speed of the vehicle at the intersection and the climbing speed of the vehicle at the straight uphill described in step S901.

In some embodiment, autonomous driving vehicles and pedestrians in similar environments can share the same prediction algorithm model, which improves the utilization rate of the algorithm.

In the above embodiment, by constructing an object prediction model for a single object, the richness of the algorithm content is increased, so that the prediction algorithm model has more model data to refer to and the calculation performance of the autonomous driving vehicle is improved. Through the obstacle model matching, a large amount of calculation power for processing perceptual analysis of obstacles is saved, Improve the safety performance of autonomous driving vehicles in actual driving.

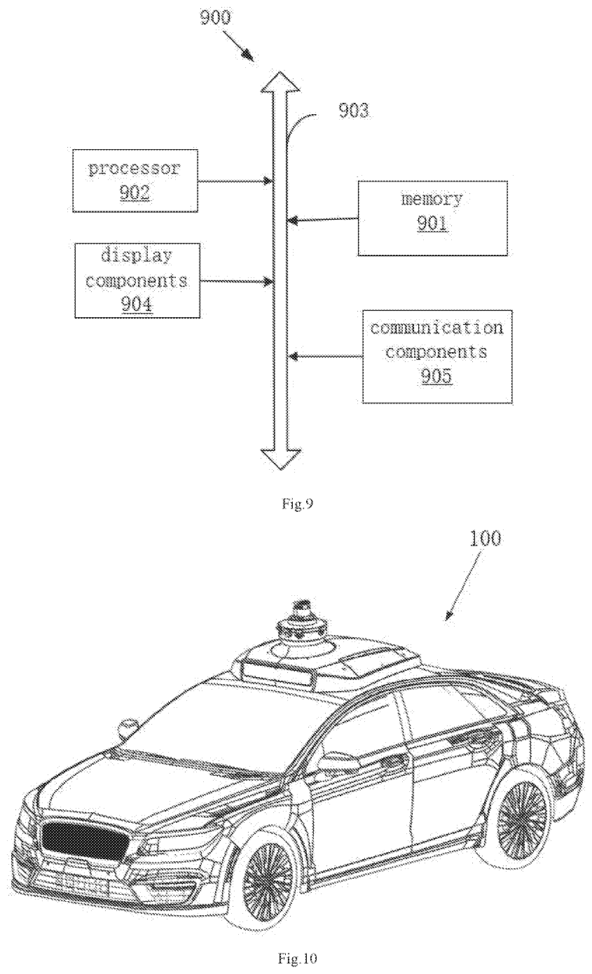

Referring to FIG. 9 and FIG. 10, FIG. 9 illustrate a block diagram of a computer device in accordance with an embodiment. FIG. 10 illustrates schematic diagram of the autonomous driving vehicle 100 with an embodiment. The computer device 900 is applied to the autonomous driving vehicle 100. The autonomous driving vehicle 100 includes a main body 99, and a computer device 900 installed in the main body 99. The computer device 900 includes a memory 901 and a processor 902. The memory 901 is configured to store program instructions of the autopilot prediction method based on case big data, and the processor 902 is configured to execute program instructions to realize the autopilot prediction method based on case big data.

The processor 902, in some embodiment, may be a Central Processing Unit (CPU), controller, microcontroller, microprocessor, or other data processing chip used to run the program instructions stored in the memory 901 that apply high-precision map to recognize traffic light.

The memory 901 includes at least one type of readable storage medium, which includes flash memory, hard disk, multimedia card, card-type memory (for example, SD or DX memory, etc.), magnetic memory, disk, optical disc, etc. Memory 901 in some embodiment may be an internal storage unit of a computer device, such as a hard disk of a computer device. Memory 901, in other embodiment, can also be a storage device for external computer devices, such as a plug-in hard disk, a Smart Media Card (SMC), a Secure Digital (SD) Card, a Flash Card, etc. equipped on a computer device. Further, the memory 901 may include both the internal and external storage units of a computer device. the memory 901 can not only be used to store the application software and all kinds of data installed in the computer equipment, such as the code to realize the method for recognizing the traffic lights using high-precision map, but also can be used to temporarily store the data that has been output or will be output.

Further, the computer device 900 may also include a bus 903, which may be a peripheral component interconnect (PCI) or an extended industry standard architecture (EISA) or the like. The bus can be divided into address bus, data bus and control bus. For the convenience of representation, only one thick line is used in FIG. 9, but it does not mean that there is only one bus or one type of bus.

Further, the computer device 900 may also include a display component 904. The display component 904 may be a light emitting diode (LED) display, a liquid crystal display, a touch type liquid crystal display, an organic light emitting diode (OLED) touch device, and the like. Among them, the display component 904 can also be appropriately called a display device or a display unit for displaying information processed in the computer device 900 and a user interface for displaying visualization.

Further, the computer device 900 may also include a communication component 905, which may optionally include a wired communication component and/or a wireless communication component (such as a Wi-Fi communication component, a Bluetooth communication component, etc.), which is generally used to establish a communication connection between the computer device 900 and other computer devices.

FIG. 9 only shows the computer device 900 with components 901-905 and program instructions for realizing the autopilot prediction method based on individual big data. It can be understood by those skilled in the art that the structure shown in FIG. 9 does not constitute a limitation on the computer device 900, and may include fewer or more components than shown in the figure, or combine some components, or different component arrangements. In the above embodiment, the computer device 900 and the processor 902 have described in detail the detailed process of executing the program instruction of the autonomous driving prediction method based on the case big data to control the computer device 900 to realize the autonomous driving prediction method based on the case big data. It will not be repeated here.

In the above embodiment, it may be achieved in whole or in part by software, hardware, firmware, or any combination thereof. When implemented in software, it can be implemented in whole or in part as a computer program product.

The computer program product includes one or more computer instructions. When the computer program instructions are loaded and executer on a computer, a process or function according to the embodiment of the disclosure is generated in whole or in part. The computer device may be a general-purpose computer, a dedicated computer, a computer network, or other programmable device. The computer instruction can be stored in a computer readable storage medium, or transmitted from one computer readable storage medium to another computer readable storage medium. For example, the computer instruction can be transmitted from a web site, computer, server, or data center to another web site, computer, server, or data center through the cable (such as a coaxial cable, optical fiber, digital subscriber line) or wireless (such as infrared, radio, microwave, etc.). The computer readable storage medium can be any available medium that a computer can store or a data storage device such as a serve or data center that contains one or more available media integrated. The available media can be magnetic (e.g., floppy Disk, hard Disk, tape), optical (e.g., DVD), or semiconductor (e.g., Solid State Disk), etc.

The technicians in this field can clearly understand the specific working process of the system, device and unit described above, for convenience and simplicity of description, can refer to the corresponding process in the embodiment of the method described above, and will not be repeated here.

In the several embodiment provided in this disclosure, it should be understood that the systems, devices and methods disclosed may be implemented in other ways. For example, the device embodiment described above is only a schematic. For example, the division of the units, just as a logical functional division, the actual implementation can have other divisions, such as multiple units or components can be combined with or can be integrated into another system, or some characteristics can be ignored, or does not perform. Another point, the coupling or direct coupling or communication connection shown or discussed may be through the indirect coupling or communication connection of some interface, device or unit, which may be electrical, mechanical or otherwise.

The unit described as a detached part may or may not be physically detached, the parts shown as unit may or may not be physically unit, that is, it may be located in one place, or it may be distributed across multiple network units. Some or all of the units can be selected according to actual demand to achieve the purpose of this embodiment scheme.

In addition, the functional units in each embodiment of this disclosure may be integrated in a single processing unit, or may exist separately, or two or more units may be integrated in a single unit. The integrated units mentioned above can be realized in the form of hardware or software functional units.

The integrated units, if implemented as software functional units and sold or used as independent product, can be stored in a computer readable storage medium. Based on this understanding, the technical solution of this disclosure in nature or the part contribute to existing technology or all or part of it can be manifested in the form of software product. The computer software product stored on a storage medium, including several instructions to make a computer equipment (may be a personal computer, server, or network device, etc.) to perform all or part of steps of each example embodiment of this disclosure. The storage medium mentioned before includes U disk, floating hard disk, ROM (Read-Only Memory), RAM (Random Access Memory), floppy disk or optical disc and other medium that can store program codes.

It should be noted that the embodiment number of this disclosure above is for description only and do not represent the advantages or disadvantages of embodiment. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above are only the preferred embodiment of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. An autonomous driving prediction method based on big data for an autonomous driving vehicle, wherein the autonomous driving prediction method comprises:
providing a plurality of prediction algorithm models associated with a target road, the plurality of the prediction algorithm model matching sub road sections of the target road correspondingly;
obtaining sensing data of sensors, the sensing data including a current position of the autonomous driving vehicle, surrounding environment data of the autonomous driving vehicle, and, driving data of the autonomous driving vehicle;
obtaining current scene data of the autonomous driving vehicle from the sensing data;
obtaining an optimal prediction algorithm model matching to a current sub road section of the target road from the plurality of the prediction algorithm models based on the current scene data of the autonomous driving vehicle;
loading the optimal prediction algorithm model;
calculating current scene data of the autonomous driving vehicle by the optimal prediction algorithm model to obtain prediction data;
generating a control command based on the prediction data; and
controlling the autonomous driving vehicle to drive according to the control command.

2. The autonomous driving prediction method as claimed in claim 1, wherein each of the plurality of the prediction algorithm models is constructed under a condition of performing multiple road tests by road test vehicles in a corresponding scene of each of the sub road sections which has the same characteristic of the same scene.

3. The autonomous driving prediction method as claimed in claim 1, wherein each of the plurality of the prediction algorithm models associated with two or more different sub road sections.

4. The autonomous driving prediction method as claimed in claim 3, wherein the prediction algorithm models contain one or more obstacle grafting models for the corresponding sub road sections; each of the obstacle grafting models is a trajectory model of an obstacle with specific behavior in corresponding sub road sections, calculating current scene data of the autonomous driving vehicle by the optimal prediction algorithm model to obtain prediction data comprises:
distinguishing one or more corresponding obstacle grafting models matched to obstacle data when the obstacle data exists in the current scene data of the autonomous driving vehicle, the obstacle data including type data for indicating the obstacle type, behavior data for indicating behavior characteristics of the obstacle, and sub road sections where the obstacle is located; and
calculating the current scene data by the one or more corresponding obstacles grafting models to generate the prediction data.

5. The autonomous driving prediction method as claimed in claim 4, wherein distinguishing one or more corresponding obstacle grafting models matched to obstacle data comprises:
distinguishing one or more obstacle grafting models matching to the sub road sections where the obstacle is located;
distinguishing one or more obstacle grafting models matching to the type data from the one or more obstacle grafting models matching to the sub road sections;
distinguishing one or more obstacle grafting models matching to the behavior data from the one or more obstacle grafting models matching to type data.

6. The autonomous driving prediction method as claimed in claim 3, wherein the prediction algorithm model contains one or more intersection prediction algorithm models associated with the intersection, calculating current scene data of the autonomous driving vehicle by the optimal prediction algorithm model to obtain prediction data comprises:
when the autonomous driving vehicle is driving in a non target road and arrives at an intersection, sensing the current intersection to get the scene data;
determining whether there exist an intersection prediction algorithm model matching to the scene data of the current intersection;
when there exist the intersection prediction algorithm model matching to the scene data of the current intersection, predicting the scene data of the current intersection to get the prediction data by the intersection prediction algorithm model matching to the scene data of the current intersection.

7. The autonomous driving prediction method as claimed in claim 3, wherein the prediction algorithm models contain one or more road section prediction algorithm models associated with interest road sections, calculating current scene data of the autonomous driving vehicle by the optimal prediction algorithm model to obtain prediction data comprises:
when the autonomous driving vehicle is driving in the non target road and reaches the interest road section, sensing the scene data of the interest road section;
determining whether there exists a road section prediction algorithm model matching to the scene data;
when there exists the road section prediction algorithm model matching to the scene data, calculating the scene data to get the prediction data by the road section algorithm model matching to the scene data of the interest road section.

8. The autonomous driving prediction method as claimed in claim 4, the prediction algorithm models contain one or more object prediction algorithm models associated with an object, each of the object prediction algorithm models is trajectory algorithm model for a corresponding object, calculating current scene data of the autonomous driving vehicle by the optimal prediction algorithm model to obtain prediction data comprises:
when the object is sensed, predicting the object to get the prediction data by one or more object prediction algorithm models associated with the object.

9. The autonomous driving prediction method as claimed in claim 8, further comprises:
obtaining behavior data of the object about behavior of an object at intersections or interest road sections of the target road; and
constructing the one or more object prediction algorithm models based on behavior data of the object.

10. The autonomous driving prediction method as claimed in claim 1, further comprises:
performing multiple road tests by the autonomous driving vehicle on the sub road section to obtain road test data;
constructing different scene data based on the road test data, each of the different scenes data containing two or more of time, locations, objects, and weather;
constructing scenes based on the road test data under corresponding scene data;
constructing the prediction algorithm models according to scene data correspondingly; and
associating the scene data with the prediction algorithm models correspondingly to obtain the prediction algorithm models associated with the sub road section.

11. An artificial intelligence apparatus for an autonomous driving vehicle, the artificial intelligence apparatus comprising:
a memory configured to store program instructions; and
one or more processors configured to execute the program instructions to perform an autonomous driving prediction method based on big data for an autonomous driving vehicle, the autonomous driving prediction method comprising:
providing a plurality of prediction algorithm models associated with a target road, the plurality of the prediction algorithm model matching sub road sections of the target road correspondingly;
obtaining sensing data of sensors, the sensing data including a current position of the autonomous driving vehicle, surrounding environment data of the autonomous driving vehicle, and, driving data of the autonomous driving vehicle;
obtaining current scene data of the autonomous driving vehicle from the sensing data;
obtaining an optimal prediction algorithm model matching to a current sub road section of the target road from the plurality of the prediction algorithm models based on the current scene data of the autonomous driving vehicle;
loading the optimal prediction algorithm model;
calculating current scene data of the autonomous driving vehicle by the optimal prediction algorithm model to obtain prediction data;
generating a control command based on the prediction data; and
controlling the autonomous driving vehicle to drive according to the control command.

12. The artificial intelligence apparatus as claimed in claim 11, wherein each of the plurality of the prediction algorithm models is constructed under a condition of performing multiple road tests by road test vehicles in a corresponding scene of each of the sub road sections.

13. The artificial intelligence apparatus as claimed in claim 11, wherein each of the plurality of the prediction algorithm models associated with two or more different sub road sections.

14. The artificial intelligence apparatus as claimed in claim 13, wherein the prediction algorithm models contain one or more obstacle grafting models for the corresponding sub road sections; each of the obstacle grafting models is a trajectory model of an obstacle with specific behavior in corresponding sub road sections, calculating current scene data of the autonomous driving vehicle by the optimal prediction algorithm model to obtain prediction data comprises:
distinguishing one or more corresponding obstacle grafting models matched to obstacle data when the obstacle data exists in the current scene data of the autonomous driving vehicle, the obstacle data including type data for indicating the obstacle type, behavior data for indicating behavior characteristics of the obstacle, and sub road sections where the obstacle is located; and
calculating the prediction data by the one or more corresponding obstacles grafting models.

15. The artificial intelligence apparatus as claimed in claim 14, wherein distinguishing one or more corresponding obstacle grafting models matched to obstacle data comprises:
distinguishing one or more obstacle grafting models matching to the sub road sections where the obstacle is located;
distinguishing one or more obstacle grafting models matching to the type data from the one or more obstacle grafting models matching to the sub road sections;
distinguishing one or more obstacle grafting models matching to the behavior data from the one or more obstacle grafting models matching to type data.

16. The artificial intelligence apparatus as claimed in claim 13, wherein the prediction algorithm model contains one or more intersection prediction algorithm models associated with the intersection, calculating current scene data of the autonomous driving vehicle by the optimal prediction algorithm model to obtain prediction data comprises:
when the autonomous driving vehicle is driving in non target road and arrives at an intersection, the autonomous driving vehicle sensing the current intersection to get the scene data;
determining whether there exist an intersection prediction algorithm model matching to the scene data of the current intersection;
when there exist the intersection prediction algorithm model matching to the scene data of the current intersection, predicting the scene data of the current intersection to get the prediction data by the intersection prediction algorithm model matching to the scene data of the current intersection.

17. The artificial intelligence apparatus as claimed in claim 13, wherein the prediction algorithm models contain one or more road section prediction algorithm models associated with interest road sections, calculating current scene data of the autonomous driving vehicle by the optimal prediction algorithm model to obtain prediction data comprises:
when the autonomous driving vehicle is driving in the non target road and reaches the interest road section, sensing the scene data of the interest road section;
whether there exists a road section prediction algorithm model matching to the scene data;
when there exists the road section predicting the scene data of the current intersection to get the prediction data by the road section algorithm model matching to the scene data of the current intersection.

18. The artificial intelligence apparatus as claimed in claim 13, the prediction algorithm models contain one or more object prediction algorithm models associated with an object, each of the object prediction algorithm models is trajectory algorithm model for a corresponding object, calculating current scene data of the autonomous driving vehicle by the optimal prediction algorithm model to obtain prediction data comprises:
when the object is sensed that the object located in the target road, predicting the object to get the prediction data by one or more object prediction algorithm models associated with the object.

19. The artificial intelligence apparatus as claimed in claim 18, further comprises:
obtaining behavior data of the object about behavior of an object at intersections or interest road sections of the target road; and
constructing object prediction algorithm models based on behavior data of the object.

20. A storage media, the storage media configured to store program instructions; the program instructions being executed by one or more processors to perform an autonomous driving prediction method based on big data for an autonomous driving vehicle, the autonomous driving prediction method comprising:
providing a plurality of prediction algorithm models associated with a target road, the plurality of the prediction algorithm model matching sub road sections of the target road correspondingly;
obtaining sensing data of sensors, the sensing data including a current position of the autonomous driving vehicle, surrounding environment data of the autonomous driving vehicle, and, driving data of the autonomous driving vehicle;
obtaining current scene data of the autonomous driving vehicle from the sensing data;
obtaining an optimal prediction algorithm model matching to a current sub road section of the target road from the plurality of the prediction algorithm models based on the current scene data of the autonomous driving vehicle;
loading the optimal prediction algorithm model;
calculating current scene data of the autonomous driving vehicle by the optimal prediction algorithm model to obtain prediction data;
generating a control command based on the prediction data; and
controlling the autonomous driving vehicle to drive according to the control command.
